(19) United States
(12) Patent Application Publication
(10) Pub. No.: US 2009/0150350 A1
(43) Pub. Date: Jun. 11, 2009

(54) Systems and methods of vehicle entertainment

(75) Inventors: Xiaoguang Yu, Wuhan (CN); Xinsheng Peng, Wuhan (CN); Xiangshan Guan, Wuhan (CN)

Correspondence Address: PATENT PROSECUTION;O2MIRCO , INC., 3118 PATRICK HENRY DRIVE, SANTA CLARA, CA, 95054, US

(73) Assignee: O2Micro, Inc.

(21) Appl. No.: 11/999,402

(22) Filed: Dec. 5, 2007

(51) Int. Cl. G06F 17/30; G06F 3/00; G06F 15/16

(52) U.S. Cl. 707/3; 715/716; 710/5; 709/219; 707/E17.032

(57) ABSTRACT

In one embodiment, a vehicle-based entertainment system comprises a network connection unit and a vehicle-based processor. The vehicle-based processor is coupled between a user interface and the network connection unit. The vehicle-based processor provides a media file list to the user interface by searching at least one media file in the remote media source according to the keyword received from the user interface. The vehicle-based processor downloads and decodes at least one target media file selected from the media file list according to the selection command received from the user interface. The remote media source is accessed by the vehicle-based processor through the network connection unit.

### BACKGROUND

1. Field of the Invention

The present invention relates to entertainment systems, and more particularly, to vehicle-based entertainment systems.

2. Description of the Related Art

As the number of vehicles distributed has increased, people tend to spend more time in vehicles. As such, many advances have been made in the development of entertainment systems that make the otherwise tedious task of riding in a vehicle more bearable. To get entertained, drivers and passengers can enjoy radio programs or a compact disc (CD) via an audio system installed in vehicles. Passengers can also watch a video compact disc (VCD) or a digital video disc (DVD) via a video system installed in vehicles.

These conventional vehicle-based entertainment systems (audio and/or video systems) allow multiple individuals to view multimedia resources within the same vehicle. However, the multimedia resources provided by these conventional vehicle-based entertainment systems are limited. Moreover, users of these conventional vehicle-based entertainment systems have to view the multimedia resources in a passive way. For example, when these conventional vehicle-based entertainment systems play music, the play list is determined by a radio station or a CD. If listeners dislike the songs in the play list, they have to switch to another CD or another radio station until a desired song is found, which can be inconvenient.

### SUMMARY

Embodiments in accordance with the present invention provide a vehicle-based entertainment system. The vehicle-based entertainment system comprises a network connection unit and a vehicle-based processor. The vehicle-based processor is coupled between a user interface and the network connection unit. The vehicle-based processor provides a media file list to the user interface by searching at least one media file in the remote media source according to a keyword received from the user interface. The vehicle-based processor downloads and decodes at least one target media file selected from the media file list according to a selection command received from the user interface. The remote media source is accessed by the vehicle-based processor through the network connection unit.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a block diagram of a vehicle entertainment system, in accordance with one embodiment of the present invention.

FIG. 2 is schematic diagram of a vehicle entertainment system, in accordance with one embodiment of the present invention.

FIG. 3A and FIG. 3B show a flowchart of a method of providing vehicle entertainment in a system, in accordance with one embodiment of the present invention.

FIG. 4 shows a flowchart of a method for providing a media file list in a vehicle-based entertainment system, in accordance with one embodiment of the present invention.

FIG. 5 is a flowchart of a method of operating a specified media server, in accordance with one embodiment of the present invention.

### DETAILED DESCRIPTION

Reference will now be made in detail to embodiments of the present invention. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

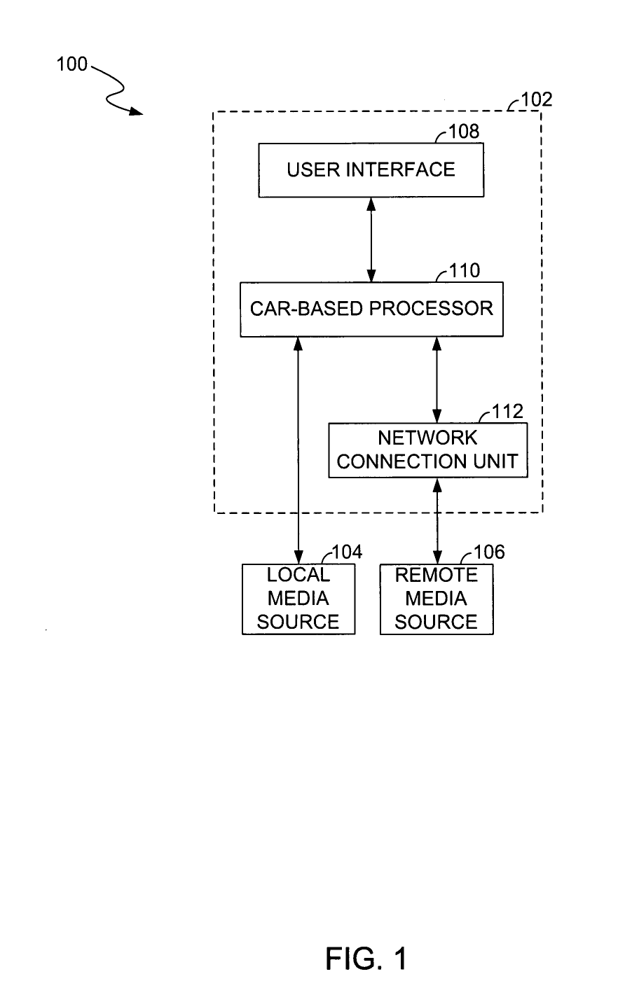

FIG. 1 is a block diagram of a vehicle entertainment system 100, in accordance with one embodiment of the present invention. The system 100 includes a vehicle-based entertainment system (vehicle-based entertainment center) 102, a local media source 104, and a remote media source 106, in one embodiment. The local media source 104 and the remote media source 106 can respectively store an amount of media resources, e.g., in forms of media files. In one embodiment, the local media source 104 can be a removable storage device (e.g., a removable disk, a CD, a VCD, a DVD, etc.) for storing media files. The vehicle-based entertainment system 102 can search these media files in the local media source 104 and/or the remote media source 106 according to user commands. These media files can be further decoded by the vehicle-based entertainment system 102 for playing.

In one embodiment, the vehicle-based entertainment system 102 includes a user interface 108, a vehicle-based processor 110, and a network connection unit 112. The user interface 108 can receive one or more keywords input by a user. The keyword can be a title, a musician, a composer, a singer, or other information related to the media files. For example, the keyword can be “Michael Jackson”, which represents a singer. The keyword can be further provided to the vehicle-based processor 110 which is coupled to the local media source 104 directly and to the remote media source 106 through the network connection unit 112. In response to the keyword, the vehicle-based processor 110 searches local media file(s) in the local media source 104 and/or remote media file(s) in the remote media source 106 according to the keyword.

According to a result of the searching, the vehicle-based processor 110 can provide a media file list to the user interface 108. The media file list represents corresponding media files (e.g., local media files and/or remote media files) found in the local media source 104 and/or the remote media source 106 according to the keyword. The media file list can also indicate information related to the found media files (e.g., title, musician, composer, singer, format, size, location, etc.). The user interface 108 displays the media file list and waits for a selection command from the user, in one embodiment. The selection command can select one or more target media files that the user wants to play from the media file list. In response to the selection command, the vehicle-based processor 110 downloads and decodes the target media file for playing.

As such, the user can enjoy media resources stored in both local media source 104 and remote media source 106. In addition, operations of searching, downloading, and playing these media resources are invisible to the user, in one embodiment. As such, the user can just enter a few user commands, e.g., a keyword and a selection command, and media files selected according to these user commands will be downloaded and played automatically. Advantageously, a play list of the system 100 is tailored according to the user demands. In addition, the system 100 not only facilitates the passengers but also allows the drivers to concentrate on driving while enjoying entertainment, thereby making the journey safer and more enjoyable.

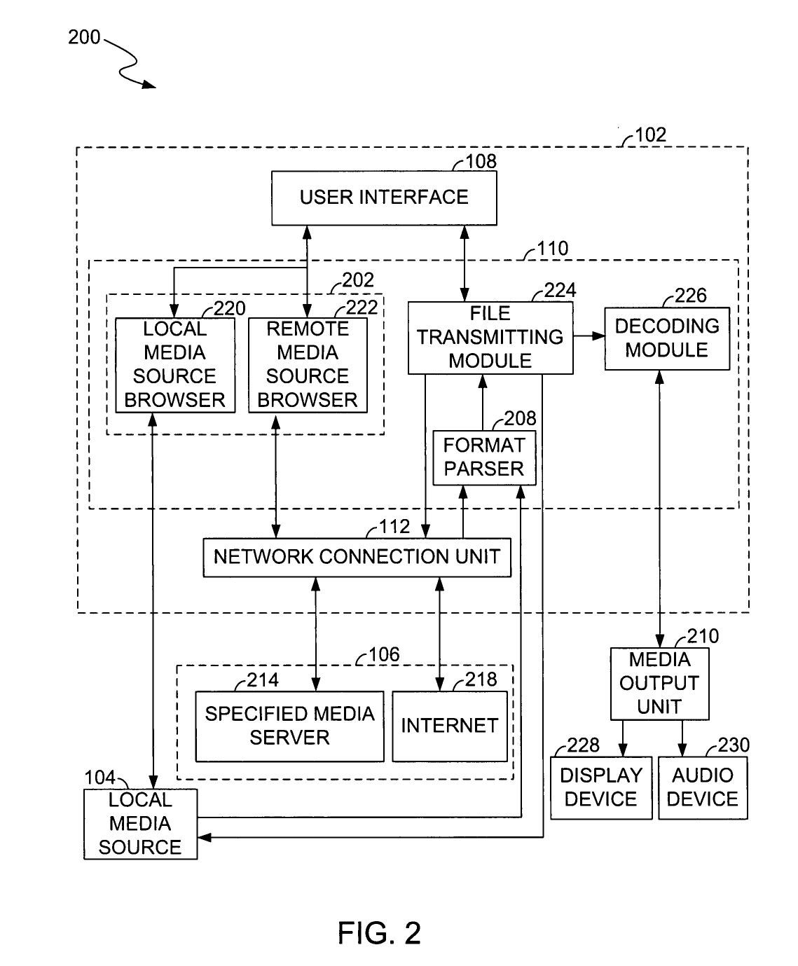

FIG. 2 illustrates a schematic diagram of a vehicle entertainment system 200, in accordance with one embodiment of the present invention. Elements labeled the same as in FIG. 1 have similar functions and will not be repetitively described herein for purposes of brevity and clarity. The system 200 includes the vehicle-based entertainment system 102, the local media source 104, the remote media source 106, a media output unit 210, a display device 228, and an audio device 230, in one embodiment. The vehicle-based entertainment system 102 includes the user interface 108, the vehicle-based processor 110, and the network connection unit 112, in one embodiment. The vehicle-based processor 110 includes a browser 202, a format parser 208, a file transmitting module 224, and a decoding module 226, in one embodiment. The browser 202 may include a local media source browser 220 and a remote server browser 222, in one embodiment. The remote media source 106 includes a specified media server 214 and an interconnected computer network (e.g., Internet) 218, in one embodiment.

The specified media server 214 can be an on-line computer with a specified location known to the vehicle-based entertainment system 102, e.g., a computer named “O2micro Media Sever”, in one embodiment. The remote media source 106 including the specified media server 214 and Internet 218 can receive a client request (e.g., download request, media list request, etc.) sent from the vehicle-based entertainment system 102. The client request is generated by the remote media source browser 222, and is transferred by the network connection unit 112 and is received by the remote media source 106, in one embodiment.

As mentioned in relation to FIG. 1, the vehicle-based processor 110 receives one or more keywords from the user interface 108 and searches media files associated with the keyword in the local media source 104 and/or the remote media source 106 in order to provide a media file list to the user interface 108. More specifically, the local media source browser 220 in the browser 202 receives the keyword from the user interface 108 and searches for media files in the local media source 104 according to the keyword. The remote server browser 222 in the browser 202 also receives the keyword from the user interface 108 and searches for media files in the specified media server 214 and/or the Internet 218 according to the keyword. Furthermore, a media list request, which is transferred by the network connection unit 112 and received by the remote media source 106, can be generated by the remote media source browser 222 to represent the keyword if the remote media source 106 is to be searched. In one embodiment, a web search engine, e.g., www. google. corm, www. yahoo. com, www. baidu. corm, etc., can be initiated for the Internet searching. Furthermore, a first searching result in the local media source 104 can be reported to the local media source browser 220 directly. A second searching result in the remote media source 106, which includes a searching result in the specified media server 214 and/or the Internet 218, can be reported to the remote media source browser 222 through the network connection unit 222. The first and second searching results are collected by the browser 202 to generate the media file list, which is in turn provided to the user interface 108 for display, in one embodiment.

As an example, assuming the keyword is “Michael Jackson”, the media file list may be shown as in Table 1, in which the title, the artist (singer), the format, and the location are indicated respectively.

TABLE 1

| Item | | | | |
|---|---|---|---|---|
| No. | Title | Artist | Format | Location |
| 01 | Heal the | Michael | MP3 Format | Removable Disk G |
| | World | Jackson | Sound | |
| 02 | Black or | Michael | Windows | O2micro Media Server |
| | White | Jackson | Media Audio | |
| | | | File | |
| 03 | Beat It | Michael | Windows | Http://www.xxxxxx.com/ |
| | | Jackson | Media Audio | MichaelJackson/.../003.wma |
| | | | File | (website address |
| | | | | shown here is just for |
| | | | | illustration purposes) |

Advantageously, the remote media source browser 222 can filter the searching result from Internet 218 to enhance the validity of website addresses in the media file list, in one embodiment. When the Internet 218 is searched for the media files associated with the keyword, the web search engine may find out a large number of website addresses, which may also include some undesirable addresses (e.g., inaccessible false addresses or addresses linked only to advertisements). With the filtering function, these undesirable addresses can be effectively filtered, such that the user can select one or more desired (valid) website addresses more efficiently.

Furthermore, the user interface 108 waits for the selection command from the user to select one or more target media files from the media file list. According to the location information of the target media file, the file transmitting module 224 downloads the target media file from the local media source 104 if the location information indicates that the target media file is located in the local media source 104. If the location information indicates that the target media file is located in the remote media source 106, a download request, which is transferred by the network connection unit 112 and received by the remote media source 106, will be generated by the file transmitting module 224 to request the specified media server 214 and/or Internet 218 to provide the target media file to the vehicle-based entertainment system 102. The file transmitting module 224 downloads the target media file from the remote media source 106 through the network connection unit 112. In the above example, if the user wants to play the song “Beat It”, the user can choose item ‘03’ at the user interface 108. According to the selection command, the file transmitting module 224 downloads the song “Beat It” from the corresponding website address.

Additionally, the format parser 208 identifies the format of the target media file during the process of downloading and provides the format information to the file transmitting module 224, in one embodiment. The decoding module 226 decodes the downloaded target media file and provides the decoded target media file to the media output unit 210. The media output unit 210 converts the decoded target media file to a number of analog signals, and outputs these analog signals to a playing device, in one embodiment. Advantageously, if the format of the target media file is a stream media according to the format parser 208, the file transmitting module 224 and the decoding module 226 can simultaneously download and decode the stream media, and send the decoded stream media to the media output unit 210 for playing. The media output unit 210 will output the analog signals to a display device 228 and an audio device 230 if the target media file is a video file, in one embodiment. The media output unit 210 will output the analog signals to the audio device 230 if the target media file is an audio file, in one embodiment.

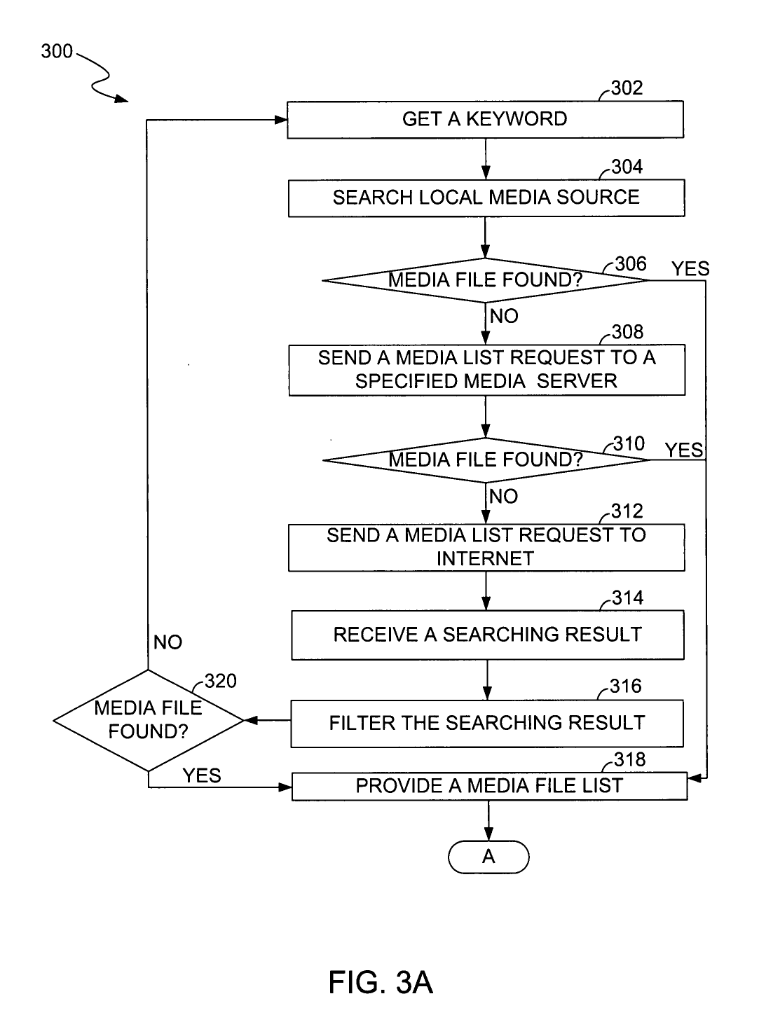

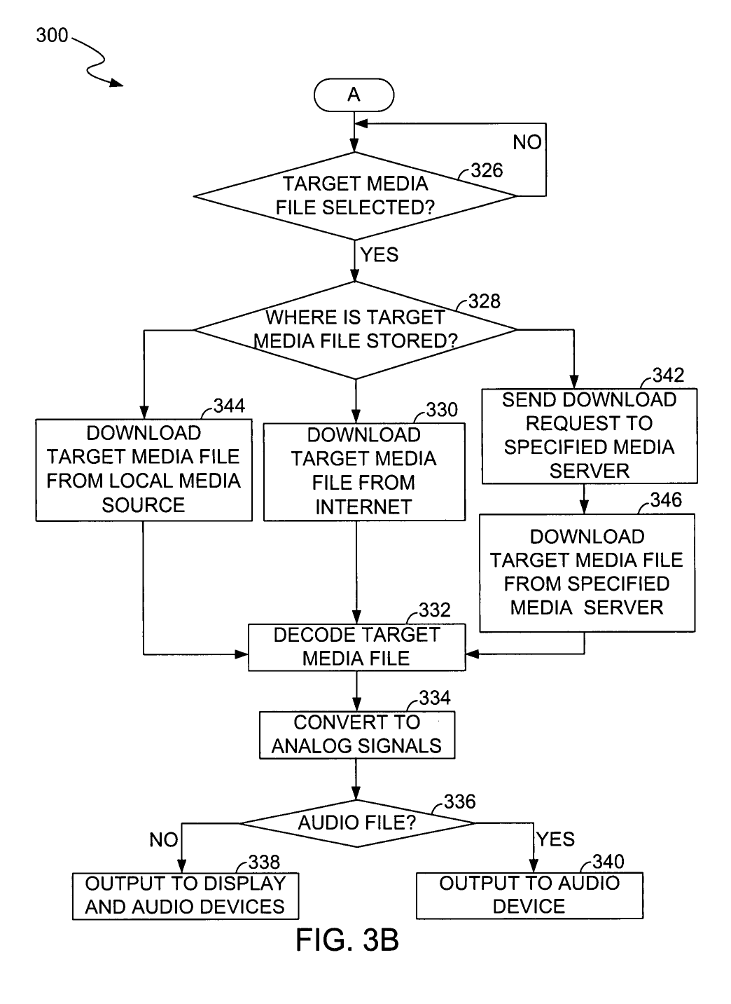

FIG. 3A and FIG. 3B illustrate an exemplary flowchart 300 of a method for providing vehicle entertainment in a vehicle-based entertainment system, in accordance with one embodiment of the present invention. More specifically, FIG. 3A illustrates a method for providing a media file list and FIG. 3B illustrates a method for downloading and playing a target media file, in one embodiment. Although specific steps are disclosed in FIG. 3A and FIG. 3B, such steps are exemplary. That is, the present invention is well suited to performing various other steps or variations of the steps recited in FIG. 3A and FIG. 3B. The flowchart 300 in FIG. 3A and FIG. 3B is described in combination with FIG. 1 and FIG. 2.

In FIG. 3A, an exemplary method for providing a media file list is illustrated. In block 302, a keyword is received at the user interface 108. For example, the keyword may be an artist (singer) name, e.g., “Michael Jackson”. The local media source 104 is searched for media files associated with the keyword by the local media source browser 220, in block 304. A searching result in the local media source 104 is checked, in block 306. If one or more media files associated with the keyword are found in the local media source 104, a media file list representative of the corresponding media files will be provided to the user interface 108, in block 318. For example, for the keyword of “Michael Jackson”, an associated media file “Heal the World” is found in a removable disk G (a local media source). The user interface 108 can display the media file list shown as “Title: Heal the World, Artist: Michael Jackson, Format: MP3 Format Sound, Location: Removable Disk G”.

If the associated media files are not found in the local media source 104, the remote media source browser 222 can generate a media list request based on the keyword and send the media list request to the specified media server 214 through the network connection unit 112, in block 308. Additionally, if the local media source 104 is not attached to the vehicle-based entertainment system 102, the media list request can be generated and sent to the specified media server 214 directly by the remote media source browser 222, thereby skipping the steps illustrated in blocks 304 and 306. In response to the media list request, the specified media server 214 is searched for the media files associated with the keyword (e.g., “Michael Jackson”), and a searching result in the specified media server can be provided to the remote media source browser 222.

In block 310, the searching result is checked by the remote media source browser 222. If one or more media files associated with the keyword are found in the specified media server 214, a media file list representative of the corresponding media files will be provided to the user interface 108, in block 318. For example, a media file named “Black or White” is found in the specified media server (e.g., O2micro Media Sever) 214. The specified media server 214 provides the searching result to the remote media source browser 222. The searching result may include the title, the artist (singer), the format and the location of the media file “Black or White”. The remote media source browser 222 generates the media file list according to the searching result and sends the media file list to the user interface 108. The user interface 108 can display the media file list shown as “Title: Black or White, Artist: Michael Jackson, Format: Windows Media Audio File, Location: O2micro Media Server”.

If the media files associated with the keyword are not found in the specified media server 214, the media list request will be further sent to the Internet 218 by the remote media source browser 222, in block 312. For example, the remote media source browser 222 generates and sends the media list request according to the keyword (e.g., “Michael Jackson”) to a web search server via the network connection unit 112. The web search server searches the Internet 218 according to the keyword “Michael Jackson” and sends a searching result of the Internet searching to the remote media source browser 222. In block 314, the searching result is received by the remote media source browser 222. The searching result can be filtered by the remote media source browser 222, in block 316.

In block 320, the searching result from the Internet 218 is checked by the remote media source browser 222. If one or more media files associated with the keyword are found in the Internet 218, a media file list will be provided to the user interface 108, in block 318. For example, the web search server finds a media file named “Beat It” on a website. If the media file “Beat It” is accessible, the information of the media file “Beat It” can be added to the media file list. In this way, the remote media source browser 222 can generate the media file list containing valid media file information. The remote media source browser 222 sends the media file list to the user interface 108. The user interface 108 can display the media file list shown as “Title: Beat It, Artist: Michael Jackson, Format: Windows Media Audio File, Location: http://www.xxxxx.com/Michael Jackson/.../003.wma”.

If media files associated with the keyword are not found in the Internet 218 or the media files found on the Internet 218 are not accessible, the browser 202 can report corresponding information to the user interface 108, and the vehicle-based entertainment system 102 will get ready to receive a new keyword, in block 302.

To summarize, according to the method of FIG. 3A, the browser 202 searches for media files in the local media source 104, the specified media server 214, and the Internet 218 sequentially according to the keyword, and terminates searching when one or more media files are found. This type of searching can be referred herein as a sequential (default) fashion. The default fashion is one of a number of searching fashions used by the browser 202. As such, the method of FIG. 3A is one of a number of methods for providing the media file list. However, the browser 202 can also search the media files in the local media source 104, the specified media server 214, and the Internet 218 in parallel (simultaneously) according to the keyword, and provide a media file list including all the media files associated with the keyword.

In FIG. 3B, a method for downloading and playing a target media file is illustrated. In block 326, the user interface 108 can continuously check a selection status until a target media file is selected.

If a target media file is selected by a selection command, a location where the target media file is stored will be checked, in block 328. If the target media file is stored in the local media source 104, the target media file will be downloaded from the local media source 104 by a file transmitting module 224, in block 344. If the target media file is stored in the specified media server 214, a download request will be sent to the specified media server 214 by the file transmitting module 224 via the network connection unit 112, in block 342. The specified media server 214 receives the download request and provides the target media file in response to the download request. In block 346, the file transmitting module 224 downloads the target media file from the specified media server 214 via the network connection unit 112. If the target media file is not found in the specified media server 214, the file transmitting module 224 may download the target media file from the Internet 218 via the network connection unit 112, in block 330.

In block 332, the target media file is decoded by the decoding module 226. More specially, a format of the target media file can be identified by a format parser 208 during downloading. If the format of the target media file is a stream media, the target media file can be downloaded and decoded simultaneously. In block 334, the decoded target media file can be converted to a number of analog signals by a media output unit 210. In block 336, whether the target media file is audio file or video file can be checked by the media output unit 210. In block 338, the number of analog signals will be output to a display device 228 and an audio device 230 by the media output unit 210 if the target media file is recognized as a video file. In block 340, the analog signals will be output to the audio device 230 by the media output unit 210 if the target media file is recognized as an audio file.

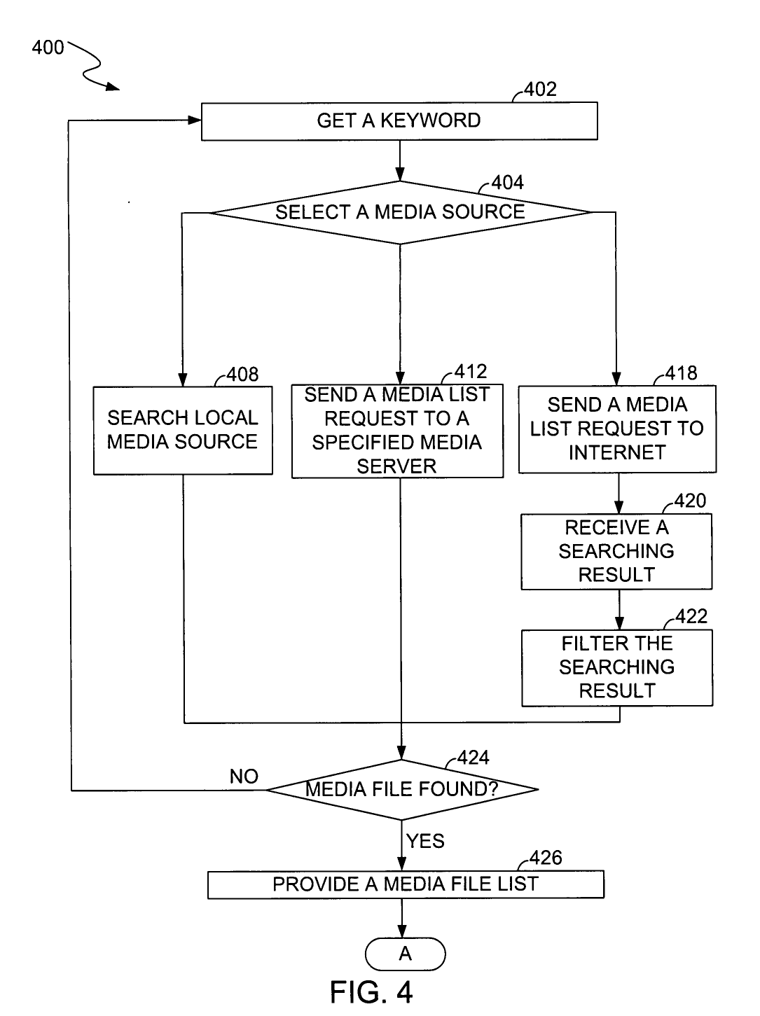

FIG. 4 illustrates a flowchart of a method for providing a media file list in a vehicle-based entertainment system, in accordance with another embodiment of the present invention. FIG. 3B illustrates a method for downloading and playing a target media file. As such, FIG. 4 in combination with FIG. 3B illustrate a flowchart of a method for providing vehicle entertainment in the vehicle-based entertainment system, in accordance with another embodiment of the present invention. Although specific steps are disclosed in FIG. 4, such steps are exemplary. That is, the present invention is well suited to performing various other steps or variations of the steps recited in FIG. 4. FIG. 4 is described in combination with FIG. 1 and FIG. 2.

In block 402, a keyword (e.g., “Michael Jackson”) is received at a user interface 108. In block 404, a media source is selected by a source command from the user. For example, the user interface 108 may display a media source list. The media source list may be shown as “1. search the local media source; 2. search the specified media server; 3. search the Internet.” The user can input the source command to make a decision of where to search the media files associated with the keyword “Michael Jackson” by selecting item 1, and/or item 2, and/or item 3. As such, the user can search the media files in one or more media sources selected from the local media source 104, the specified media server 214, and Internet 218, in one embodiment.

If the local media source 104 is selected at the user interface 108, the local media source 104 will be searched for the media files according to the keyword by a local media source browser 220, in block 408. If the specified media server 214 is selected, a media list request will be sent to the specified media server 214 by the remote media source browser 222 to search for corresponding media files in the specified media server 214, in block 412. If the Internet 218 is selected, the media list request will be sent to the Internet 218 by the remote media source browser 222 to search for corresponding media files from the Internet 218, in block 418. In block 420, a searching result from the Internet 218 is received by the remote media source browser 222. In block 422, the searching result can be filtered by the remote media source browser 222 according to certain standard for providing a desired media file list.

In block 424, a result of the searching for the media files in the local media source 104, and/or in the specified media server 214, and/or on the Internet 218 is checked by the browser 202. If one or more corresponding media files are found, the browser 202 will provide a media file list according to a searching result in the local media source 104, a searching result in the specified media server 214, or a filtered searching result from the Internet 218. The media file list is then provided to the user interface 108 by the browser 202, in block 426. The user interface 108 displays the media file list. If the media files associated with the keyword are not found, the vehicle-based entertainment system 102 will get ready to receive a new keyword, in block 402.

To summarize, according to the method shown in FIG. 4, the browser 202 selectively searches the local media source 104, the specified media server 214, and the Internet 218 for the media files associated with the keyword according to a source command of the user. This type of searching can be referred herein as a customized fashion. The customized fashion is one of a number of searching fashions applied by the browser 202. As such, the method of FIG. 4 is one of a number of methods for providing the media file list.

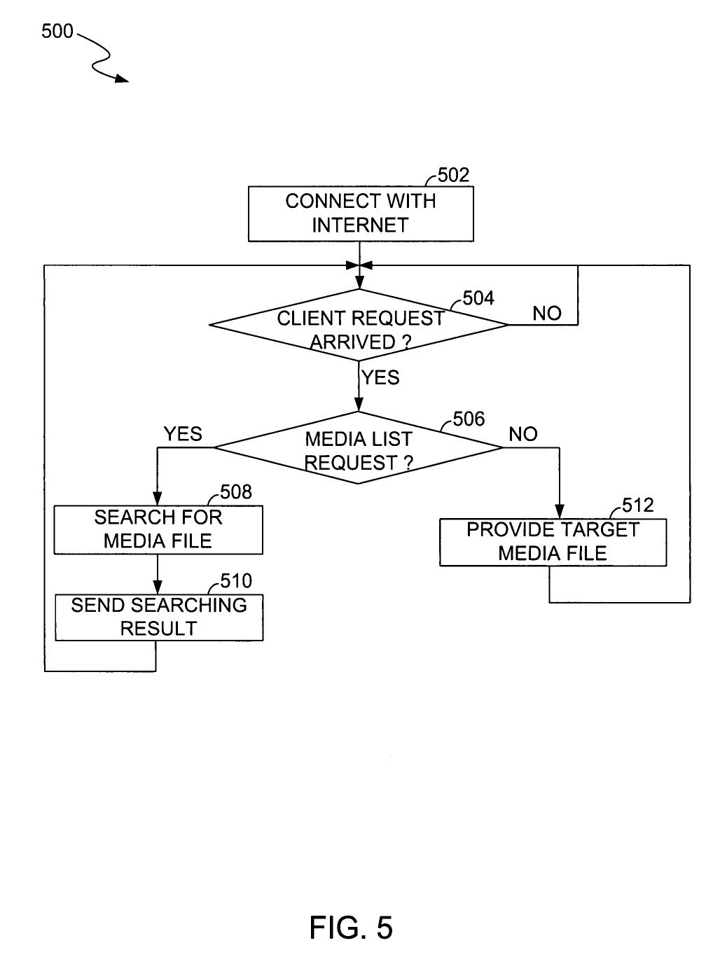

FIG. 5 illustrates a flowchart 500 of a method of operating a specified media server, in accordance with one embodiment of the present invention. Although specific steps are disclosed in FIG. 5, such steps are exemplary. That is, the present invention is well suited to performing various other steps or variations of the steps recited in FIG. 5. FIG. 5 is described in combination with FIG. 2.

In block 502, the specified media server 214 is connected to the Internet 218. In block 504, the specified media server 214 checks whether a client request sent by a vehicle-based entertainment system 102 has been received or not. The specified media server 214 can continuously check until a client request has been received. The client request can be a media list request and/or a download request, etc. In block 506, a type of the client request can be checked by the specified media server 214. If the client request is a media list request, the specified media server 214 will be searched for media files according to the media list request, in block 508. The specified media server 214 sends the searching result to the vehicle-based entertainment system 102, in block 510. After sending the searching result, the flowchart 500 returns to the block 504 and the specified media server 214 goes on waiting for a next client request. If the client request is a download request, the specified media server 214 provides one or more target media files to the vehicle-based entertainment system 102 according to the download request, in block 512. After transmitting the media file, the flowchart 500 returns to the block 504 and the specified media server 214 goes on waiting for a next client request.

In one embodiment, the vehicle-based entertainment system 102 can provide abundant multimedia resources to a user. The multimedia resources can be obtained from both the local media source 104 inside the vehicle and the remote media source 106 outside the vehicle. Furthermore, the vehicle-based entertainment system 102 can also enable the user to make a customized media file list which can provide media files that the user is interested in. Moreover, the procedures of obtaining the media file list and playing the target media files can be done by the vehicle-based entertainment system 102 automatically and can be invisible to the user, in one embodiment. The operations which the user needs to conduct can be simple, in one embodiment. As a result, the vehicle-based entertainment system 102 provides an efficient and convenient way of vehicle entertainment.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A vehicle-based entertainment system comprising:
a network connection unit operable for providing access to a remote media source; and
a vehicle-based processor coupled between a user interface and said network connection unit and operable for providing a media file list to said user interface by searching at least one remote media file in said remote media source according to a keyword received from said user interface, and operable for downloading at least one target media file selected from said media file list according to a selection command received from said user interface,
wherein said remote media source is accessed by said vehicle-based processor through said network connection unit.

2. The vehicle-based entertainment system of claim 1, wherein said vehicle-based processor is operable for providing said media file list by searching at least one local media file in a local media source according to said keyword.

3. The vehicle-based entertainment system of claim 2, wherein said local media source comprises a removable storage device.

4. The vehicle-based entertainment system of claim 2, wherein said vehicle-based processor is operable for searching said at least one local media file in said local media source and searching said at least one remote media file in said remote media source in a sequential fashion.

5. The vehicle-based entertainment system of claim 2, wherein said vehicle-based processor is operable for selectively searching said local media source and said remote media source according to a source command.

6. The vehicle-based entertainment system of claim 2, wherein said vehicle-based processor further comprising:
a local media source browser operable for searching said at least one local media file in said local media source to provide said media file list.

7. The vehicle-based entertainment system of claim 1, wherein said remote media source comprises a specified media server.

8. The vehicle-based entertainment system of claim 1, wherein said remote media source comprises an interconnected computer network.

9. The vehicle-based entertainment system of claim 8, wherein said vehicle-based processor is operable for searching said at least one remote media file from said interconnected computer network and for filtering a searching result to provide said media file list.

10. The vehicle-based entertainment system of claim 1, wherein said vehicle-based processor further comprising:
a remote media source browser operable providing a client request to said remote media resource and for searching said at least one remote media file in said remote media source via said network connection unit to provide said media file list.

11. The vehicle-based entertainment system of claim 1, wherein said vehicle-based processor is operable for simultaneously downloading and decoding said at least one target media file for playing.

12. The vehicle-based entertainment system of claim 1, wherein said vehicle-based processor further comprising:
a file transmitting module operable for downloading said at least one target media file according to said selection command;
a format parser coupled to said file transmitting module operable for identifying a format of said at least one target media file; and
a decoding module coupled to said file transmitting module and operable for decoding said at least one target media file and for providing a decoded target media file to a media output unit for playing.

13. A method for providing entertainment in a vehicle, comprising:
searching a remote media file in a remote media source outside said vehicle according to a keyword to obtain a first searching result;
providing a media file list according to said first searching result;
selecting a target media file from said media file list according to a selection command;
downloading said target media file from said remote media source; and
playing said target media file.

14. The method of claim 13, further comprising:
searching a local media file in a local media source inside said vehicle according to said keyword to obtain a second searching result; and
providing said media file list according to said first searching result and said second searching result.

15. The method of claim 13, further comprising:
receiving a source command from a user interface; and
selectively searching said local media source and said remote media source according to said source command.

16. The method of claim 13, further comprising:
generating a media list request representative of said keyword, wherein said media list request is received by said remote media source.

17. The method of claim 13, wherein said remote media source is selected from at least a specified media server and an interconnected computer network.

18. The method of claim 17, further comprising:
searching said interconnected computer network for said remote media file; and
filtering a result of said interconnected computer network searching to provide said media file list.

19. The method of claim 13, further comprising:
parsing a format of said target media file; and
downloading and playing said target media file simultaneously if said format of said target media file comprises a stream media.

20. A system for providing vehicle entertainment, comprising:
a plurality of media sources comprising a local media source and a remote media source;
a vehicle-based entertainment center operable for providing a media file list by searching at least one media file in said plurality of media sources according to a keyword and for downloading at least one target media file selected from said media file list according to a selection command; and
a media output unit coupled to said vehicle-based entertainment center and operable for playing said target media file.

21. The system of claim 20, wherein said vehicle-based entertainment center comprises a network connection unit, and wherein said remote media source is accessed by said vehicle-based entertainment center through said network connection unit.

22. The system of claim 20, wherein said remote media source is selected from at least a specified media server and an interconnected computer network.

23. The system of claim 20, wherein said vehicle-based entertainment center is operable for searching said local media source and said remote media source for said at least one media file in a sequential fashion.

24. The system of claim 20, wherein said vehicle-based entertainment center is operable for selectively searching said local media source and said remote media source for said at least one media file according to a source command.
